(19) United States
(12) Patent Application Publication
(10) Pub. No.: US 2022/0237723 A1
(43) Pub. Date: Jul. 28, 2022

(54) VERIFYING CREDENTIALS

(71) Applicant: Formee Express Pty Ltd, North Melbourne (AU)

(72) Inventor: Azeezur Rahaman, North Melbourne (AU)

(21) Appl. No.: 17/155,907

(22) Filed: Jan. 22, 2021

(51) Int. Cl. G06Q 50/20; H04L 29/06

(52) U.S. Cl. CPC G06Q 50/2053; H04L 63/0884; H04L 63/0815

(57) ABSTRACT

Technologies are described herein to verifying credentials associated with an applicant includes requesting verification for an unsubscribed applicant's credentials using a non-portal-based medium, storing verified credentials for the unsubscribed applicant in a second database on the subscription-based portal, verifying a subscribed applicant's credentials using a subscription-based portal, storing the verified credentials for the subscribed applicant in a database on the subscription-based portal, and managing access to the verified credentials for the subscribed applicant from the database on the subscription-based portal.

### TECHNICAL FIELD

The embodiments described herein pertain generally to a centralized platform for facilitating efficient and streamlined verification of applicants' credentials for one or more institutions.

### BACKGROUND

A global economy requires a global workforce that require a global education. For both an applicant and an institution, whether the institution be of higher learning, e.g., colleges and universities, or professional, the application process may be an arduous one. Issues that may hinder, impede, or otherwise curtail the process may be rooted in lack of familiarity, trust, and/or coordination among the institutions and sources of credentials attributed to the applicant and for which verification is sought.

### SUMMARY

In one example embodiment, a non-transitory computer-readable medium for a verification platform stores executable instructions that, when executed, cause one or more processors to enroll an applicant for credential verification services, receive credentials corresponding to the applicant, store the received credentials, verify authenticity of the received credentials for a subscribed institution, and provide access to the verified credentials corresponding to the applicant for the subscribed institution upon request.

In another example embodiment, a non-transitory computer-readable medium stores components executable on a verification platform. The components include a receiver configured to receive communications from unsubscribed institutions, a transmitter configured to transmit communications to the unsubscribed institutions, a portal configured to facilitate communications with subscribed institutions, a partner database configured to manage subscriptions to services rendered on the verification platform, a verified credential database configured to store credentials corresponding to the subscribed institutions, and a non-verified credential database configured to store credentials corresponding to the unsubscribed institutions.

In yet another example embodiment, a method for verifying credentials corresponding to an applicant includes requesting verification for an unsubscribed applicant's credentials using a non-portal-based medium, storing verified credentials for the unsubscribed applicant in a second database on the subscription-based portal, verifying a subscribed applicant's credentials using a subscription-based portal, storing the verified credentials for the subscribed applicant in a database on the subscription-based portal, and managing access to the verified credentials for the subscribed applicant from the database on the subscription-based portal.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows a block diagram representing a credential verification system, in accordance with non-limiting example embodiments described and recited herein;

FIG. 2 shows a block diagram representing a verification platform, in accordance with non-limiting example embodiments described and recited herein;

FIG. 3 shows a processing flow for at least a portion of verifying credentials, in accordance with non-limiting example embodiments described and recited herein;

FIG. 4 shows a processing flow for at least another portion of verifying credentials, in accordance with non-limiting example embodiments described and recited herein;

FIG. 5 shows a processing flow for another aspect of verifying credentials, in accordance with non-limiting example embodiments described and recited herein; and

FIG. 6 shows an illustrative computing embodiment, in which any of the processes and sub-processes for verifying credentials may be implemented as executable instructions stored on a computer-readable medium.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described and recited herein, as well as illustrated in the drawings, may be arranged, substituted, combined, separated, and designed in a wide variety of different configurations, all of which are explicitly contemplated herein.

In the present description and recitation, the following terms may be used, in addition to their accepted meaning, as follows:

Applicant may refer to a person applying for acceptance or admission to an institution and, as part of the application process, for whom credentials are to be verified by the institution. Applicant may also refer to a person applying for employment, acceptance for which may be contingent upon verification of credentials. Though verifying credentials may differ for an applicant to an institution as opposed to an applicant for employment, unless context dictates otherwise, general references may be made herein to an applicant or to applicants.

Institution may refer to an institution of higher learning, e.g., a college, university, trade school, etc. However, in keeping with the spirit and scope intended by the descriptions and recitations herein, non-limiting examples of an institution may further include any academic institution that implements selective admission or any place of employment for which an applicant's academic credentials are to be verified. Unless context dictates otherwise, general references may be herein to an institution or to institutions.

Subscribers may refer to an applicant who has paid for, or otherwise been granted, a subscription to services rendered by a platform, in accordance with the examples described, recited, or even suggested herein. Subscribers may also refer to institutions that, likewise, have paid for, or otherwise been granted, a subscription to services rendered by a platform, in accordance with the examples described, recited, or even suggested herein. Though implementation of the services rendered by the platform may differ in various regards for an applicant as opposed to for an institution, unless context dictates otherwise, general references may be made herein to a subscriber or to subscribers.

Credentials may refer to recorded or memorialized academic or educational accomplishments or qualifications that are at least requested in order to qualify for acceptance or admission to an institution. Non-limiting examples of credentials, in accordance with examples of verifying described and recited herein, include degrees, diplomas, or evidence of other alleged accomplishments. For an applicant for employment, non-limiting examples of credentials may include professional certificates or documentation for work experience. Unless context dictates otherwise, general references may be made herein to a credential or to credentials.

Credential sources may refer to a person or other representation of an institution capable of verifying one or more credentials for an applicant. Non-limiting examples of a credential source, in accordance with the examples of verifying described and recited herein may include a standardized testing clearinghouse or other academic institution, a place of employment, etc. That is, as described and recited herein, institutions may request verification as well as provide verification.

Verification may refer to a proof of certification of a credential from a credential source. As described and recited herein, verification may be granted and received in various forms including, but not limited to, a simple acknowledgement provided by an authorized entity representing the credential source; a digital mark, e.g., watermark, on a file; or a digital certificate.

Platform may refer to a technology suite of unified software provided and/or implemented by a vendor or entity. As described and recited herein, a platform may implement a diversity of functionalities and may be expandable. Thus, a platform, as described and recited herein, may include but not be limited to a utility platform, which provides services that may be scaled for non-paying customers and for subscribers, or a marketplace platform, which is a multi-sided platform that connects supply with demand.

As set forth above, described and recited herein are methods, programs, systems, and components pertaining to verifying credentials.

Further, in accordance with the platform described and recited herein, a subscriber student applicant may have his or her application to one or more institutions streamlined by implementing a single iteration of application process, with credentials verified via the platform and then stored in a database on the platform. The institutions may then access the verified credentials without additional input from the student applicant. Further still, the portal described and recited herein may provide both prospective and actual student applicants opportunities to learn about multiple educational institutions on a single platform and also enable student applicants to track their respective applications via a single source.

Further still, in accordance with the platform described and recited herein, a subscriber institution may have its marketing outreach to prospective student applicants broadened because of, in part, the streamlined application process facilitated by services rendered on the platform. Thus, not only may subscriber institutions gain access to a broader pool of applicants, but also may more easily identify those highly qualified within the applicant pool based on access to a centralized database of applicants' credentials that may be available as a subscriber. That is, for subscriber institutions, the platform may provide a multitude of analytics to identify highly qualified student applicants and further streamline the application process for all student applicants.

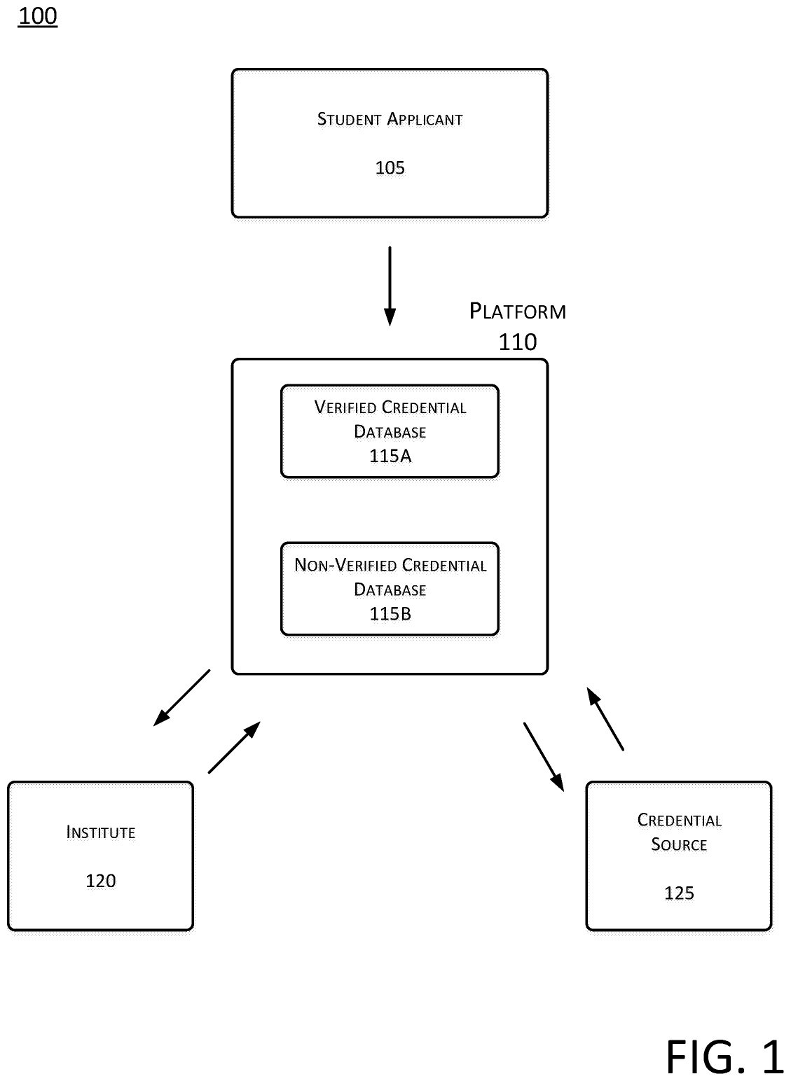

FIG. 1 shows a block diagram representing a credential verification system, in accordance with non-limiting example embodiments described and recited herein. As depicted, system 100 includes at least a student applicant 105, platform 110 with corresponding verified credential database 115A and non-verified credential database 115B, institution 120, and credential source 125.

Student applicant 105 may refer to a person applying for acceptance or admission to an institution and, as part of the application process, for whom credentials are to be verified by the institution.

Student applicant 105 may be communicatively coupled to platform 110 via a computing device that may be, or include, a smart phone, tablet computer, notebook computer, personal computer, and/or personal communication terminal, configured to be communicatively coupled to at least platform 110 over at least one of a wired or wireless link or a LAN or WAN connection, serially or in parallel.

Further, a subscriber student applicant may be communicatively coupled to platform 110 via a version or instance of an application that may be programmed, designed, and/or configured to be installed and executed upon the computing device for student applicant 105 to facilitate interactive communication with platform 110. By using the application installed on the user device, student applicant 105 may securely log-in to platform 110 prior to interactive communication therebetween.

Alternatively, student applicant 105 may securely interact with platform 110 via a web browser that facilitates interactive communication between the respective user device for student applicant 105 and an internet-based portal for platform 110. If student applicant 105 is a subscriber to the services rendered on platform 110, secure log-in may be facilitated on the internet-based portal for platform 110. If student applicant 105 is not a subscriber, interactive communication with portal 110 may be implemented after log-in as a guest or log-in on the basis of a trial subscription.

Platform 110 may refer to a technology suite of unified software, implemented by one or multiple servers hosted on a cloud-based infrastructure, to facilitate a streamlined application process that provides convenience and efficiencies for both student applicant 105 and various institutions. As non-limiting examples of services rendered on platform 110, subscriptions for both student applicant 105 and institution 120 may be managed, credentials for student applicant 105 may be verified both actively and passively, both verified and non-verified credentials for student applicant 105 may be stored, and access to both verified and non-verified credentials for student applicant 105 may be securely granted to one or more institutions.

Verified credential database 115A may refer to computer data storage, associated with platform 110, designed, programmed, or otherwise configured to receive credentials corresponding to student applicant 105 that have been verified by one or more institutions. Verified credential database 115A may further be designed, programmed, or otherwise configured to be directly or indirectly accessed by a subscribing institution that seeks access to one or more verified credentials for student applicant 105.

Non-verified credential database 115B may refer to computer data storage, which may be separate from or connected to verified credential database 115A, associated with platform 110, designed, programmed, or otherwise configured to receive credentials corresponding to student applicant 105 that have not yet been verified by any institution. Non-verified credential database 115B may further be designed, programmed, or otherwise configured to be directly or indirectly accessed by a subscribing institution that seeks access to one or more such credentials for student applicant 105.

Institution 120 may refer to an institution of higher learning, e.g., a college, university, trade school, etc., that implements selective admission to which student applicant 105 applies and for which academic credentials for student applicant 105 are to be verified.

Credential source 125 may refer to a person or automated representation of institution 120 capable of verifying one or more credentials for student applicant 105. As set forth prior, non-limiting examples of credential source 125 may include a standardized testing clearinghouse or other academic institution, etc.

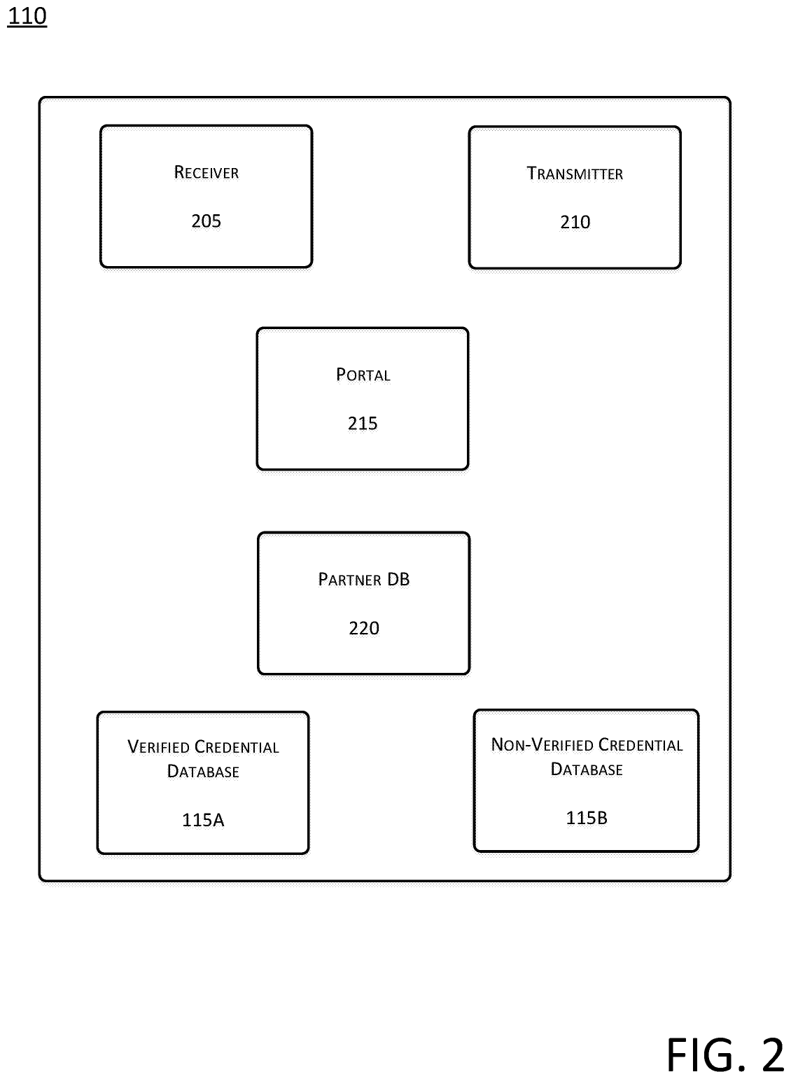

FIG. 2 shows a block diagram representing a verification platform, in accordance with non-limiting example embodiments described and recited herein. As depicted, platform 110 includes at least receiver 205, transmitter 210, portal 215, partner database 220, and verified credential database 115A and non-verified credential database 115B. Although illustrated as discrete components, various components may be divided into additional components, combined into fewer components, or eliminated altogether while being contemplated within the scope of the disclosed subject matter. Those skilled in the art would understand that each function and/or operation of the components of FIG. 2 may be implemented, individually and/or collectively, by a wide range of hardware, software, firmware, or any combination thereof.

Receiver 205 may be designed, programmed, or otherwise configured to receive communications from unsubscribed students or unsubscribed institutions.

Communications received by receiver 205 from an unsubscribed student 105 may include, but not be limited to, requests to have credentials associated with an application from student applicant 105 stored on platform 110, as part of the application process to one or more institutions for student applicant 105. That is, credentials stored on platform 110 may be accessed by multiple institutions. Therefore, receiver 205 may receive at least one communication from a version or instance of a software application associated with platform 110 that is executing on a user device corresponding to unsubscribed student 105 and on which unsubscribed student 105 is logged-in as a guest user. Alternatively, receiver 205 may receive at least one communication from an internet browser on which a website associated with platform 110 is executing on the user device corresponding to unsubscribed student 105, by which unsubscribed student 105 is logged-in as a guest user.

Whether received via application or web browser, a communication received by receiver 205 may be automated in the form of selections from a menu of communication options. In accordance with at least one example embodiment, the request may be received in text via the application, website, or even via email. Regardless of the format by which the communication is received, the request may include at least portions of pertinent identifying information for student applicant 105 and a request to have credentials corresponding to student applicant 105 stored on platform 110. Thus, the request may include one or more links to one or more credential sources from which one or more credentials for student applicant 105 may be obtained and/or verified. In accordance with at least one example embodiment, the request may include digital files, e.g., transcripts, to be verified for student applicant 105.

Communications received by receiver 205 from unsubscribed institutions may include responses to verification requests sent by transmitter 210 corresponding to platform 110. Therefore, receiver 205 may receive at least one communication from an unsubscribed institution in the form of selections from a menu of communication options on a website for platform 110, on which secured communications may be facilitated. A link to the website for platform 110 may be provided in a communication to the unsubscribed institution transmitted by transmitter 210. In accordance with other example embodiments, receiver 205 may receive a communication from an unsubscribed institution in the form of text via the website for platform 110 or even by email.

Transmitter 210 may be designed, programmed, or otherwise configured to transmit communications to the unsubscribed students or the unsubscribed institutions.

Communications transmitted by transmitter 210 to one or more unsubscribed students may also be transmitted via the application or website in the form of selections from a menu of communication options. In accordance with at least one example embodiment, the communication may be transmitted in text via the application, website, or even via email. Regardless of the format by which the communication is transmitted, the communication to unsubscribed student 105 may include, but not be limited to, confirmation of receipt of a prior communication, a request for further information, confirmation of verification of one or more credentials for student applicant 105, a solicitation for subscription to the services rendered on platform 110, etc.

Communications transmitted by transmitter 210 to one or more unsubscribed institutions may include a request for verification of one or more credentials for a respective unsubscribed student 105, although access by institutions to such credentials may be contingent upon the unsubscribed student subscribing to services provided by the platform. Therefore, in accordance with at least one example embodiment, transmitter 210 may transmit at least one communication, e.g., an email, to an unsubscribed institution, that includes a link to the website for platform 110, as described above. According to at least one other example embodiment, the communication may include a text request for verification of the one or more credentials, transmitted by an automated email.

Portal 215 may be designed, programmed, or otherwise configured to facilitate communications with subscribed institutions in the form of a website, online forum, or restricted intranet to which access is granted to subscribers that have securely logged-in. Communications between platform 110 and subscribed student applicants 105 and subscribed institutions may be securely conducted via selections from a menu of communication options in a user interface or, according to at least one example embodiment, via text communications.

Communications received by portal 215 from a subscribed student applicant 105 may include, but not be limited to, requests to have credentials corresponding to student applicant 105 stored on platform 110, as part of the application process to one or more institutions for student applicant 105. The request may include one or more links to one or more credential sources from which one or more credentials for student applicant 105 may be obtained and/or verified. In accordance with at least one example embodiment, the request may include digital files, e.g., transcripts, to be verified for student applicant 105.

Communications transmitted by portal 215 to a subscribed student applicant may be transmitted in the form of selections from a menu of communication options. In accordance with at least one example embodiment, the communication may be transmitted in text via the application or secured website. Regardless of the format by which the communication is transmitted, the communication to subscribed student applicant 105 may include, but not be limited to, confirmation of receipt of a prior communication, a request for further information, confirmation of verification of one or more credentials for student applicant 105, etc.

Communications transmitted by portal 215 to one or more institutions may include a request for verification of one or more credentials for a subscribed student applicant 105. Therefore, in accordance with at least one example embodiment, portal 215 may transmit at least one communication to an institution that includes a link to the website for platform 110, as described above.

Partner database 220 may be designed, programmed, or otherwise configured to manage subscriptions to services rendered on the verification platform. In accordance with at least one example embodiment, partner database 220 may store at least pertinent identification information for subscribed student applicants and subscribed institutions. Further, partner database 220 may be designed, programmed, or otherwise configured to facilitate secure log-in for all subscribers, whether log-in is implemented via application, website, or even email.

Partner database 220 may further be designed, programmed, or otherwise configured with a controller to regulate access to verified credential database 115A for institutions, both subscribed and unsubscribed.

Verified credential database 115A may be designed, programmed, or otherwise configured to store credentials corresponding to the subscribed institutions. In accordance with at least some example embodiments, verified credentials may be stored as digital files, e.g., transcripts; or as links to institutions that provide online access to verified credentials.

In accordance with at least some embodiments, verified credentials may be transferred or otherwise assigned to verified credential database 115A, by partner database 220, from non-verified credential database 1153, upon verification of respective credentials received by receiver 205 or portal 215.

Non-verified credential database 1153 may be designed, programmed, or otherwise configured to store credentials corresponding to the unsubscribed institutions. In accordance with at least some example embodiments, unverified credentials may be stored as digital files, e.g., transcripts; or as links to institutions that provide online access to unverified credentials. According to at least one example embodiment, unverified credentials may be received by receiver 205 or via portal 215.

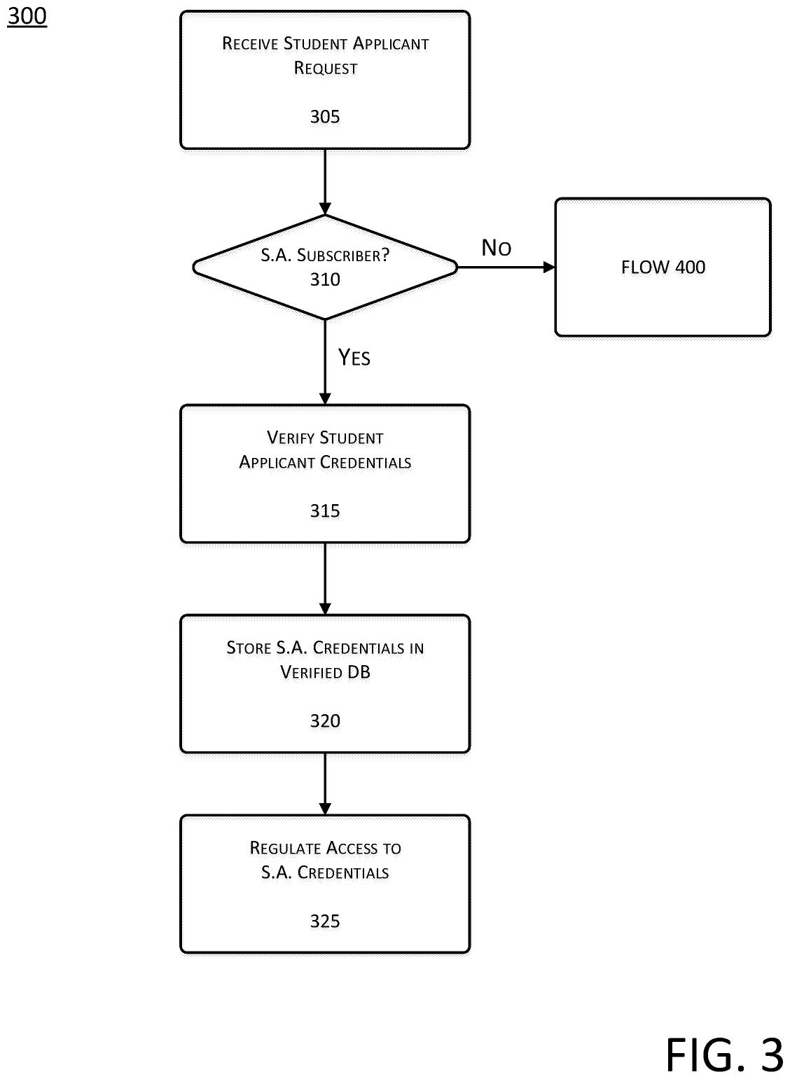

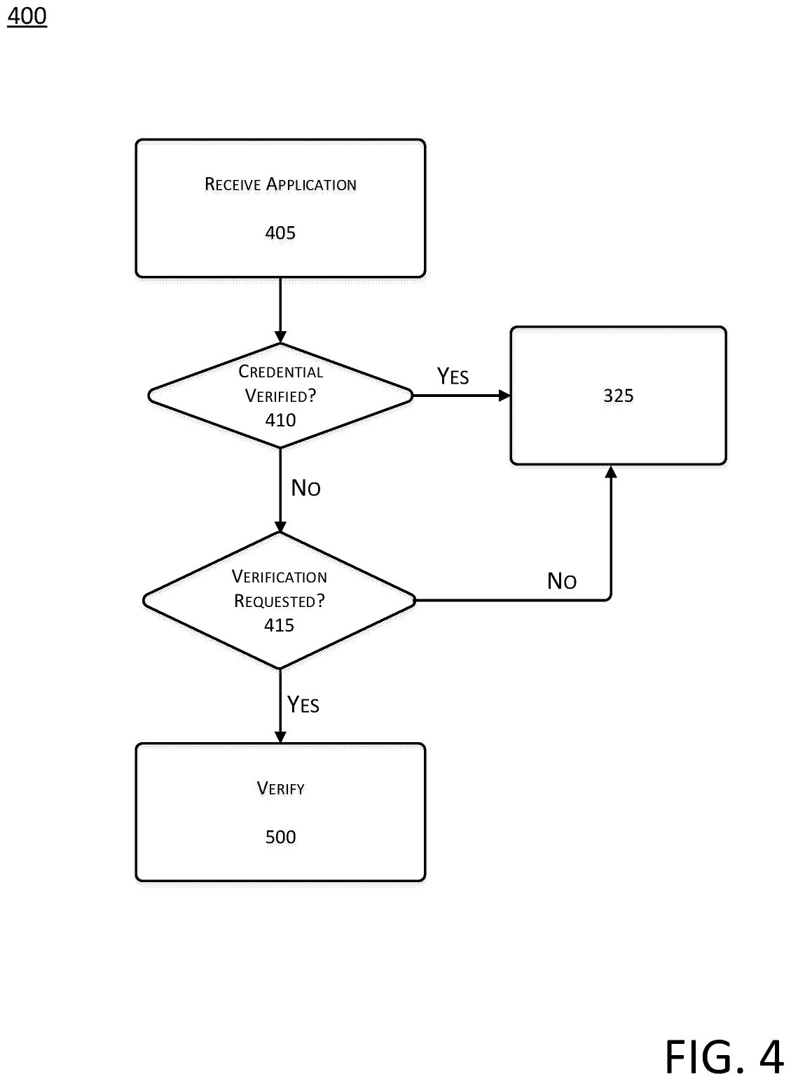

FIG. 3 shows a processing flow for at least a portion of verifying credentials, in accordance with non-limiting example embodiments described and recited herein. As depicted, processing flow 300 includes operations executed by various components of system 100, including platform 110. However, processing flow 300 is not limited to such components and operations, as obvious modifications may be made by re-ordering two or more of the operations described here, eliminating at least one of the operations, adding further operations, substituting components, or even having various components assuming operational roles accorded to other components in the following description. Processing flow 300 may include various operations, functions, or actions as illustrated by one or more of blocks 305, 310, 315, 320, 325, and processing flow 400, which is described in accordance with FIG. 4. These various operations, functions, or actions may be implemented on or by, e.g., software, program code, or program instructions executable by a digital processor that causes the functions to be performed. Processing may begin at block 305.

At block 305 (Receive Student Applicant Request), a request for credential verification, which may be included in an application for acceptance or admission by an institution, may be received from a student applicant 105.

At decision block 310 (Student Applicant Subscriber?) the request is received by receiver 205 if requesting student applicant 105 is a subscriber to the services provided by platform 110, as determined by the controller for partner database 220. Thus, if “No,” processing may proceed from decision block 310 to flow 400, as described in accordance with FIG. 4. However, the request is received by portal 215 if requesting student applicant 105 is a subscriber to the services provided by platform 110. Thus, if “Yes,” processing may proceed from decision block to block 315.

At block 315 (Verify Student Applicant Credentials), portal 215 may transmit to an institution a request for verification of one or more credentials corresponding to the application received from subscribed student applicant 105. Processing may proceed from block 315 to block 320.

At block 320 (Store Student Applicant Credentials in Verified Database), having received verification of the one or more credentials for subscribed student applicant 105 on portal 110, a controller for partner database 220 may render the verified credentials to be stored in verified credential database 115A, as described above. Processing may proceed from block 320 to block 325.

At block 325 (Regulate Access to Student Applicant Credentials), a controller for partner database 220, may grant access to the verified credentials for student applicant 105 for subscribed institutions to which student applicant 105 has applied for acceptance or admission.

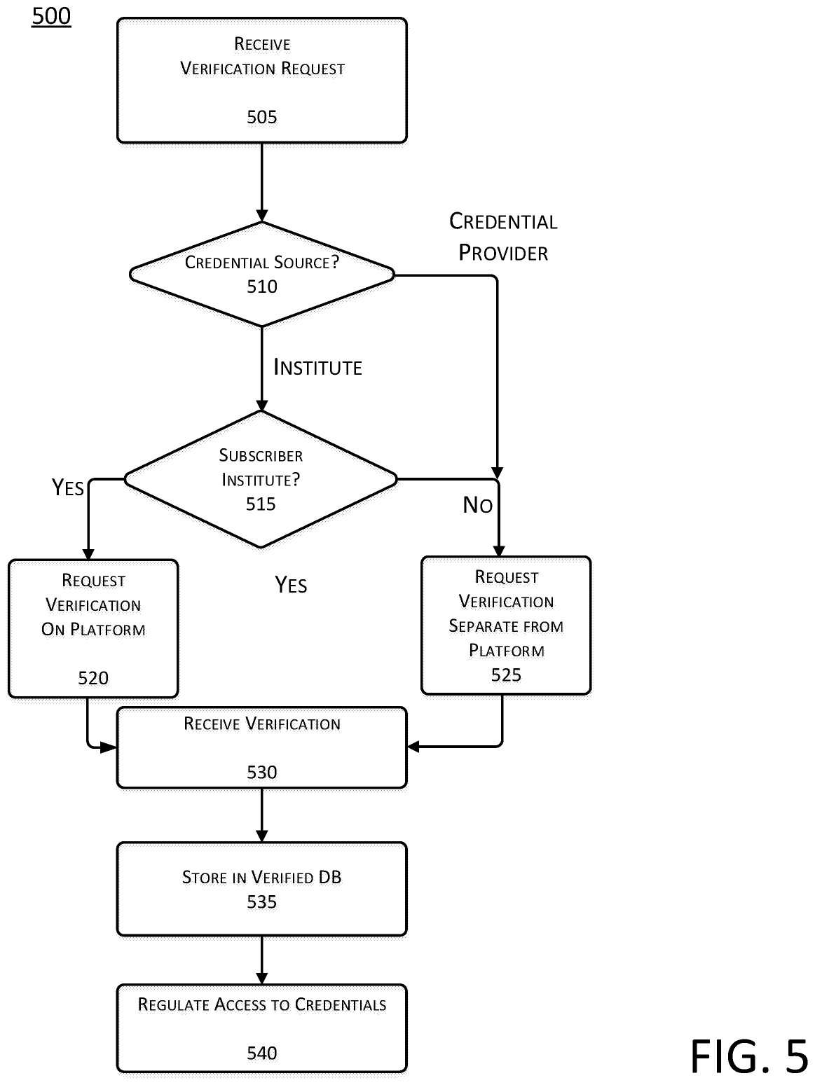

FIG. 4 shows a processing flow for at least another portion of verifying credentials, in accordance with non-limiting example embodiments described and recited herein. More particularly, processing flow 400 includes operations executed by various components of system 100, including platform 110, upon a determination of “No” at decision block 310 of process 300, described with reference to FIG. 3. As with processing flow 300, processing flow 400 is also not limited to the components of system 100 and/or the operations of processing flows 300 or even 400, as obvious modifications may be made by re-ordering two or more of the operations described here, eliminating at least one of the operations, adding further operations, substituting components, or even having various components assuming operational roles accorded to other components in the following description. Processing flow 400 may include various operations, functions, or actions as illustrated by one or more of blocks 405, 410, 415, as well as blocks 325 and 500, which are described in accordance with FIGS. 3 and 5, respectively. These various operations, functions, or actions may be implemented on or by, e.g., software, program code, or program instructions executable by a digital processor that causes the functions to be performed. Processing may begin at block 405.

At block 405 (Receive Application), as determined by the controller for partner database 220, an application for acceptance or admission by an institution may be received by receiver 205 from unsubscribed student 105. Processing may proceed from block 405 to decision block 410.

At decision block 410 (Credential Verified?), the controller for partner database 220 may determine whether the one or more credentials corresponding to the application received from unsubscribed student 105 are verified. If the one or more credentials are verified, the controller for partner database 220 may render the verified credentials to be stored in verified credential database 115A. Thus, if “Yes,” processing may proceed from decision block 410 to block 325, described in accordance with FIG. 3. However, if the one or more credentials are not verified, the controller for partner database 220 may render the verified credentials to be stored in non-verified credential database 115B. If “No,” processing may proceed from decision block 410 to decision block 415.

At decision block 415 (Verification Requested?), the controller for partner database 220 may determine whether a request for the one or more credentials for unsubscribed student 105 has been received from an institution to which student applicant 105 has applied for acceptance or admission. If “No,” processing may proceed from decision block 415 to block 325, at which the controller for partner database 220 would continue to monitor requests for the one or more credentials for student applicant 105, although access by institutions to such credentials may be contingent upon the unsubscribed student subscribing to services provided by the platform. If “Yes,” processing may proceed from decision block 415 to processing flow 500, described in accordance with FIG. 5.

FIG. 5 shows a processing flow for another aspect of verifying credentials, in accordance with non-limiting example embodiments described and recited herein. More particularly, processing flow 500 includes operations executed by various components of system 100, including platform 100, to respond to a request for verification of one or more credentials for student applicant 105, from decision block 415 described above in accordance with FIG. 4. However, processing flow 400 is not limited to the components of system 100 or operations of FIGS. 3-5, as obvious modifications may be made by re-ordering two or more of the operations described here, eliminating at least one of the operations, adding further operations, substituting components, or even having various components assuming operational roles accorded to other components in the following description. Processing flow 500 may include various operations, functions, or actions as illustrated by one or more of blocks 505, 510, 515, 520, 525, 530, 535, and 540. These various operations, functions, or actions may be implemented on or by, e.g., software, program code, or program instructions executable by a digital processor that causes the functions to be performed. Processing may begin at block 305.

At block 505 (Receive Verification Request) a request for verification of one or more credentials for student applicant 105 is received, on platform 110, from an institution to which student applicant 105 has applied for acceptance or admission. Processing may proceed from block 505 to decision block 510.

At decision block 510 (Credential Source?), the controller for partner database 220 may determine sources for received credentials associated with the application from student applicant 105. For received credentials for which the source is determined to be an institute, processing may proceed from decision block 510 to decision block 515. For received credentials for which the source is determined to be a credential source, processing may proceed from decision block 510 to block 525.

At decision block 515 (Subscriber Institute?), the controller for partner database 220 may determine whether the institute from which credentials associated with the application from student applicant 105 issued is a subscriber to the services provided by platform 110. If “Yes,” processing may proceed from decision block 515 to block 520. If “No,” processing may proceed from decision block 515 to block 525.

At block 520 (Request Verification on Platform), portal 215 may facilitate communications with a subscriber institute to request verification of one or more credentials associated with the application from student applicant 105. Processing may proceed from block 520 to block 530.

At block 525 (Request Verification Separate from Platform), transmitter 210 may transmit to a credential source or to an unsubscribed institute a request for verification of one or more credentials associated with the application from student applicant 105. Therefore, in accordance with at least one example embodiment, transmitter 210 may transmit at least one communication, e.g., an email, to an unsubscribed institution, that includes a link to the website for platform 110, as described above. According to at least one other example embodiment, the communication may include a text request for verification of the one or more credentials, transmitted by an automated email.

At block 530 (Receive Verification), receiver 205 may receive verification for one or more credentials associated with the application from student applicant 105 from either of a credential provider or an unsubscribed institution. According to alternative example embodiments, verification for one or more credentials associated with the application from student applicant 105 from a subscribed institution may be received via portal 215. Processing may proceed from block 530 to block 535.

At block 535 (Store in Verified Credential Database), the controller for partner database 220 may render the verified credentials to be stored in verified credential database 115A. Processing may proceed from block 535 to block 540.

At block 540 (Regulate Access to Credentials), the controller for partner database 220 may control access to the one or more verified credentials associated with the application for student applicant 105 to subscribed institutions.

Accordingly, platform 110 provides a secure and streamlined verification process for verifying credentials for applicants.

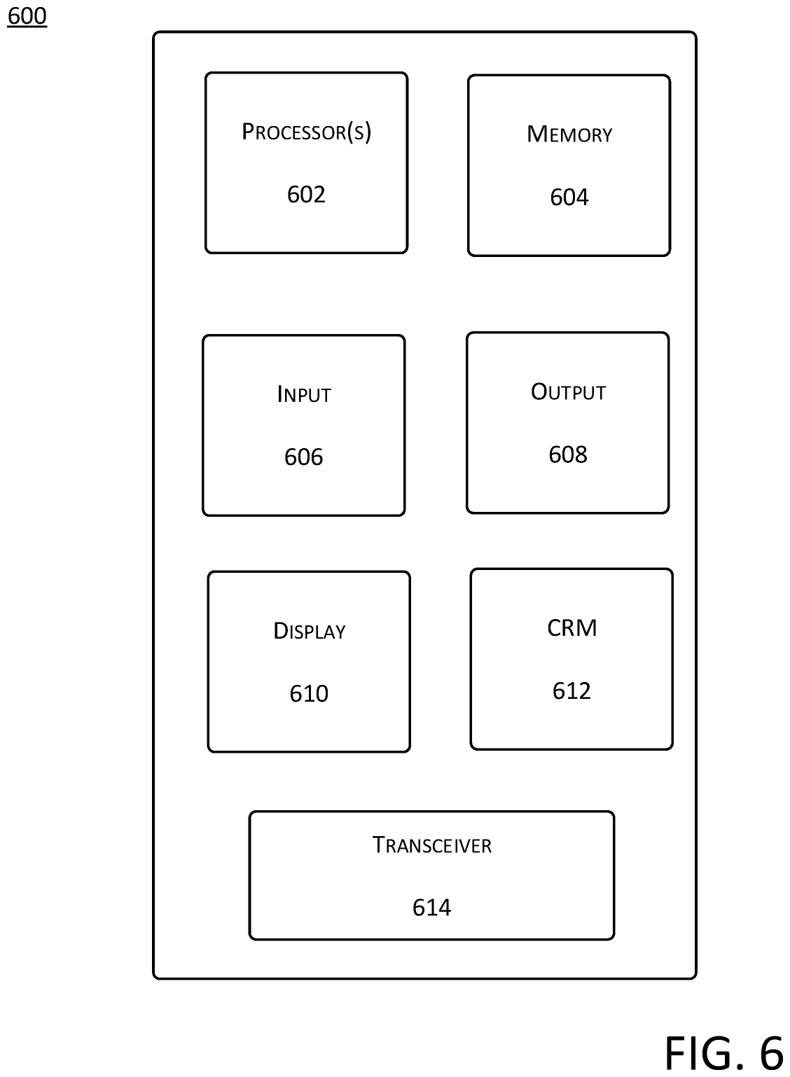

FIG. 6 shows an illustrative computing embodiment, in which aspects of verifying credentials may be implemented as executable instructions stored on a computer-readable medium, in accordance with at least some embodiments described and recited herein. The computer-readable instructions may, for example, be executed by a processor of a device, as referenced herein, having a network element and/or any other device corresponds to thereto, particularly as applicable to the applications and/or programs described above corresponding to system 100 for verifying credentials.

In a very basic configuration, a computing device 600 may typically include, at least, one or more processors 602, a system memory 604, one or more input components 606, one or more output components 608, a display component 610, a computer-readable medium 612, and a transceiver 614.

Processor 602 may refer to, e.g., a microprocessor, a microcontroller, a digital signal processor, or any combination thereof, akin to digital processor 110 described in accordance with FIG. 1.

Memory 604 may refer to, e.g., a volatile memory, non-volatile memory, or any combination thereof. Memory 604 may store, therein, an operating system, an application, and/or program data. That is, memory 604 may store executable instructions to implement any of the functions or operations described above and, therefore, memory 604 may be regarded as a computer-readable medium.

Input component 606 may refer to a built-in or communicatively coupled keyboard, touch screen, or telecommunication device. Alternatively, input component 606 may include a microphone that is configured, in cooperation with a voice-recognition program that may be stored in memory 604, to receive voice commands from a user of computing device 600. Further, input component 606, if not built-in to computing device 600, may be communicatively coupled thereto via short-range communication protocols including, but not limitation, radio frequency or Bluetooth.

Output component 608 may refer to a component or module, built-in or removable from computing device 600, that is configured to output commands and data to an external device.

Display component 610 may refer to, e.g., a solid state display that may have touch input capabilities. That is, display component 610 may include capabilities that may be shared with or replace those of input component 606.

Computer-readable medium 612 may refer to a separable machine-readable medium that is configured to store one or more programs that embody any of the functions or operations described above. That is, computer-readable medium 612, which may be received into or otherwise connected to a drive component of computing device 600, may store executable instructions to implement any of the functions or operations described above. These instructions may be complimentary or otherwise independent of those stored by memory 604.

Transceiver 614 may refer to a network communication link for computing device 600, configured as a wired network or direct-wired connection. Alternatively, transceiver 614 may be configured as a wireless connection, e.g., radio frequency (RF), infrared, Bluetooth, and other wireless protocols.

Aspects:

Aspect 1. A non-transitory computer-readable medium for a verification platform having executable instructions stored thereon, which, when executed, cause one or more processors to:

enroll an applicant for credential verification services;

receive credentials corresponding to the applicant;

store the received credentials;

verify authenticity of the received credentials for a subscribed institution; and

provide access to the verified credentials corresponding to the applicant for the subscribed institution upon request.

Aspect 2. The computer-readable medium of Aspect 1, wherein the verification platform comprises:

the one or more processors configured to execute the executable instructions;

a secured portal configured to receive verified credentials;

at least one database configured to store the verified credentials;

a receiver configured to received non-verified credentials; and

at least one database configured to store the non-verified credentials.

Aspect 3. The computer-readable medium of Aspect 1 or 2, wherein the verification platform further comprises:

a transceiver to communicate with unsubscribed institutions.

Aspect 4. The computer-readable medium of any of Aspects 1-3, wherein the applicant is a student applying for acceptance by multiple institutions.

5. The computer-readable medium of any of Aspects 1-4, wherein the multiple institutions include educational institutions.

Aspect 6. A non-transitory computer-readable medium storing components executable on a verification platform, the executable components comprising:

a receiver configured to receive communications from unsubscribed institutions;

a transmitter configured to transmit communications to the unsubscribed institutions;

a portal configured to facilitate communications with subscribed institutions;

a partner database configured to manage subscriptions to services rendered on the verification platform;

a verified credential database configured to store credentials corresponding to the subscribed institutions; and

a non-verified credential database configured to store credentials corresponding to the unsubscribed institutions.

Aspect 7. The computer-readable medium of Aspect 6, wherein the verification platform comprises multiple servers hosted on a cloud-based infrastructure and the services rendered on the verified platform include:

verifying authenticity of received credentials for the subscribed institutions; and

provide access to the verified credentials corresponding to applicants to the subscribed institutions.

Aspect 8. The computer-readable medium of Aspects 6 or 7, wherein the unsubscribed institutions include applicants to institutions that require verified credentials from the applicants.

Aspect 9. The computer-readable medium of any of Aspects 6-8, wherein the unsubscribed institutions include institutions that require verified credentials from applicants.

Aspect 10. The computer-readable medium of any of Aspects 6-9, wherein the subscribed institutions include applicants to institutions that require verified credentials from the applicants.

Aspect 11. The computer-readable medium of any of Aspects 6-10, wherein the subscribed institutions include institutions that require verified credentials from applicants.

Aspect 12. The computer-readable medium of any of Aspects 6-11, wherein the receiver is configured to receive emails from the unsubscribed institutions.

Aspect 13. The computer-readable medium of Aspects 6-12, wherein the transmitter is configured to transmit emails to the unsubscribed institutions.

Aspect 14. The computer-readable medium of any of Aspects 6-13, wherein the portal is configured to facilitate an exchange of messages between any of the subscribed institutions on the platform after secure log-in by the respective subscribed institutions.

Aspect 15. A method of verifying credentials corresponding to an applicant, the method comprising:

requesting verification for an unsubscribed applicant's credentials using a non-portal-based medium;

storing verified credentials for the unsubscribed applicant in a second database on the subscription-based portal;

granting access to the verified credentials for the unsubscribed applicant to only subscribing institutions;

verifying a subscribed applicant's credentials using a subscription-based portal;

storing the verified credentials for the subscribed applicant in a database on the subscription-based portal; and

managing access to the verified credentials for the subscribed applicant from the database on the subscription-based portal.

Aspect 16. The method of Aspect 15, wherein the subscription-based portal is included in a verification platform that comprises multiple servers hosted on a cloud-based infrastructure, and services rendered on the verified platform include:

verifying authenticity of received credentials for subscribers; and

provide access to the verified credentials for subscribers.

Aspect 17. The method of Aspect 15 or 16, wherein the subscribers include applicants to institutions that require verified credentials from the applicants.

Aspect 18. The method of any of Aspects 15-17, wherein the subscribers include institutions that require verified credentials from applicants.

Aspect 19. The method of any of Aspects 15-18, wherein the subscription-based portal facilitates an exchange of messages between any of the subscribed institutions on the platform after secure log-in by the respective subscribed institutions.

Aspect 20. The method of any of Aspects 15-19, wherein the non-portal-based medium includes email.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A non-transitory computer-readable medium for a verification platform having executable instructions stored thereon, which, when executed, cause one or more processors to:
enroll an applicant for credential verification services;
receive credentials corresponding to the applicant;
store the received credentials;
verify authenticity of the received credentials for a subscribed institution; and
provide access to the verified credentials corresponding to the applicant for the subscribed institution upon request.

2. The computer-readable medium of claim 1, wherein the verification platform comprises:
the one or more processors configured to execute the executable instructions;
a secured portal configured to receive verified credentials;
at least one database configured to store the verified credentials;
a receiver configured to received non-verified credentials; and
at least one database configured to store the non-verified credentials.

3. The computer-readable medium of claim 2, wherein the verification platform further comprises:
a transceiver to communicate with unsubscribed institutions.

4. The computer-readable medium of claim 1, wherein the applicant is a student applying for acceptance by multiple institutions.

5. The computer-readable medium of claim 4, wherein the multiple institutions include educational institutions.

6. A non-transitory computer-readable medium storing components executable on a verification platform, the executable components comprising:
a receiver configured to receive communications from unsubscribed institutions;
a transmitter configured to transmit communications to the unsubscribed institutions;
a portal configured to facilitate communications with subscribed institutions;
a partner database configured to manage subscriptions to services rendered on the verification platform;
a verified credential database configured to store credentials corresponding to the subscribed institutions; and
a non-verified credential database configured to store credentials corresponding to the unsubscribed institutions.

7. The computer-readable medium of claim 6, wherein the verification platform comprises multiple servers hosted on a cloud-based infrastructure and the services rendered on the verified platform include:
verifying authenticity of received credentials for the subscribed institutions; and
provide access to the verified credentials corresponding to applicants to the subscribed institutions.

8. The computer-readable medium of claim 6, wherein the unsubscribed institutions include applicants to institutions that require verified credentials from the applicants.

9. The computer-readable medium of claim 6, wherein the unsubscribed institutions include institutions that require verified credentials from applicants.

10. The computer-readable medium of claim 6, wherein the subscribed institutions include applicants to institutions that require verified credentials from the applicants.

11. The computer-readable medium of claim 6, wherein the subscribed institutions include institutions that require verified credentials from applicants.

12. The computer-readable medium of claim 6, wherein the receiver is configured to receive emails from the unsubscribed institutions.

13. The computer-readable medium of claim 6, wherein the transmitter is configured to transmit emails to the unsubscribed institutions.

14. The computer-readable medium of claim 6, wherein the portal is configured to facilitate an exchange of messages between any of the subscribed institutions on the platform after secure log-in by the respective subscribed institutions.

15. A method of verifying credentials corresponding to an applicant, the method comprising:
requesting verification for an unsubscribed applicant's credentials using a non-portal-based medium;
storing verified credentials for the unsubscribed applicant in a second database on the subscription-based portal;
verifying a subscribed applicant's credentials using a subscription-based portal;
storing the verified credentials for the subscribed applicant in a database on the subscription-based portal; and
managing access to the verified credentials for the subscribed applicant from the database on the subscription-based portal.

16. The method of claim 15, wherein the subscription-based portal is included in a verification platform that comprises multiple servers hosted on a cloud-based infrastructure, and services rendered on the verified platform include:
verifying authenticity of received credentials for subscribers; and
provide access to the verified credentials for subscribers.

17. The method of claim 16, wherein the subscribers include applicants to institutions that require verified credentials from the applicants.

18. The method of claim 16, wherein the subscribers include institutions that require verified credentials from applicants.

19. The method of claim 15, wherein the subscription-based portal facilitates an exchange of messages between any of the subscribed institutions on the platform after secure log-in by the respective subscribed institutions.

20. The method of claim 15, wherein the non-portal-based medium includes email.
